(19) United States
(12) Patent Application Publication
(10) Pub. No.: US 2010/0153365 A1
(43) Pub. Date: Jun. 17, 2010

(54) PHRASE IDENTIFICATION USING BREAK POINTS

(76) Inventors: Hadar Shemtov, Palo Alto, CA (US); Tapas Kanungo, San Jose, CA (US); Rajhans Samdani, Urbana, IL (US); Donald Metzler, Santa Clara, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/334,725

(22) Filed: Dec. 15, 2008

(51) Int. Cl. G06F 7/06; G06F 17/30

(52) U.S. Cl. 707/722; 707/E17.014

(57) ABSTRACT

Disclosed herein are systems and methods for identifying phrases using break points. Break points can be identified using stop words identified in content. Identified phrases can be used to generate a summary of the content.

### FIELD OF THE DISCLOSURE

The present disclosure relates to identifying phrase break using points, and more particularly to identifying phrases, or clauses or fragments, in a document using words in the document to identify break points, the phrases for use, for example, in the generation of a summary of the document.

### BACKGROUND

There is a wealth of information available to users. On the web, for example, a user can search for information on virtually any topic. Typically, a web search returns a set of results containing a number of links to resources, such as documents or files containing content. In addition, the web search results typically include a brief summary of the content referenced by the link. The brief summary is intended to provide the user with information to allow the user to determine whether or not the user wants to click on the link and open the content referenced by the link. Brevity in the summary is important, since there is a limited amount of space on a display screen that displays the web search results and it is beneficial to be able to show as many of the web search results in the available space on the display screen. For example, the available space may only allow approximately ten results, or items, with two lines per item.

In one conventional approach, a summary is generated by first determining the structure, e.g., identifying subject, verb, noun, verb, adjective, adverb, object, etc. of a sentence in which a search term occurs. At the very least, this approach is time consuming. The approach must be adapted to suit a language's structure, which can vary based on the language that is being used. In addition, information available on the web is not always structurally, e.g., grammatically, correct, which can lead to a summary that is not useful to the user. For example, material contained in blogs, e.g., texting abbreviation/acronyms, is not always structurally and grammatically correct.

### SUMMARY

The present disclosure seeks to address failings in the art and to provide systems and methods for identifying phrases using break points. In accordance with one or more embodiments, content is broken up into phrases, or clauses or fragments, using stop words. In accordance with one or more embodiments, the identified phrases can be used to generate a summary of the content.

By way of a non-limiting example, embodiments of the present disclosure avoid the need to break a sentence down into its structural, e.g., grammatical parts, and/or to identify parts of speech used in the sentence. By virtue of this arrangement, advantageously, embodiments of the present disclosure can be efficiently used to identify phrases in any number of different languages, regardless of structure, e.g., language independence.

In accordance with one or more embodiments, a method is provided, which identifies word pairs in a sentence selected from a document, each word pair having consecutive first and second words, generates, for each of the identified word pairs, a word pair score, selects at least two of the identified word pairs based on the word pair score relative to word pair scores of other ones of the identified word pairs, and identifies at least one phrase from the document, each identified phrase being defined by two of the selected word pairs.

In accordance with one or more embodiments, a computer-readable medium is provided, which tangibly embodies program code stored thereon, the program code comprising code to identify word pairs in a sentence selected from a document, each word pair having consecutive first and second words, code to generate, for each of the identified word pairs, a word pair score, code to select at least two of the identified word pairs based on the word pair score relative to word pair scores of other ones of the identified word pairs, and code to identify at least one phrase from the document, each identified phrase being defined by two of the selected word pairs.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides a general overview of components for use in accordance with one or more embodiments of the present disclosure.

FIG. 2 provides an overview of components of a phrase identification/generation system in accordance with one or more embodiments of the present disclosure.

FIG. 3 provides some examples of scoring based on query term proximity and/or ordering in accordance with one or more embodiments of the present disclosure.

FIG. 4 provides an example of word pair scoring in accordance with one or more embodiments of the present disclosure.

FIG. 5 provides an example of a phrase generated by a phrase generator in accordance with one or more embodiments of the present disclosure.

FIG. 6, which comprises FIGS. 6A to 6C, provides an example of a phrase generation process flow in accordance with one or more embodiments of the present disclosure.

### DETAILED DESCRIPTION

In general, the present disclosure includes a phrase generation/identification system, method and architecture.

Certain embodiments of the present disclosure will now be discussed with reference to the aforementioned figures, wherein like reference numerals refer to like components.

In accordance with one or more embodiments, a system, method and architecture of generating, or identifying, phrases, e.g., phrases extracted from sentences contained in a document. Phrase, fragment and clause are terms used interchangeably herein. In accordance with one or more embodiments the term document, as used herein, refers to any collection of words, text, characters, symbols, sounds, etc. of any language and represented in any form or format and/or stored by any means. By way of a non-limiting example, in a case that the document is a collections of words, a phrase, or fragment or clause, can comprise one or more of the words in the document.

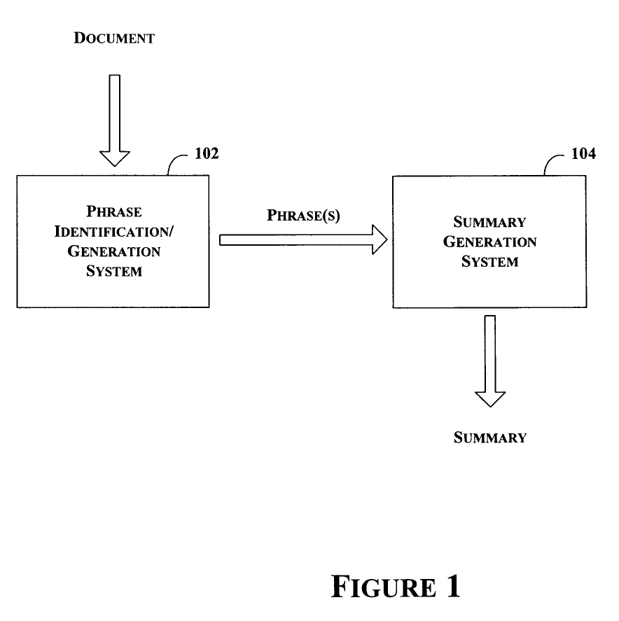

FIG. 1 provides a general overview of components for use in accordance with one or more embodiments of the present disclosure. In accordance with one or more embodiments, a document is input to phrase identification/generation system 102, which generates one or more phrases. The one or more phrases generated by system 102 can be input to another system, such as summary generation system 104, which generates a summary comprising the one or more phrases provided by phrase identification/generation system 102. By way of a non-limiting example, summary generation system 104 can be a search engine, which performs a search to generate search results using a query that includes one or more query, or search terms. By way of a further non-limiting example, the document(s) input to the phrase identification/generation system 102 comprise the search results generated by the search engine. It should be apparent, however, that summary generation system 104 can be any type of system, and is not limited to a search engine, or system.

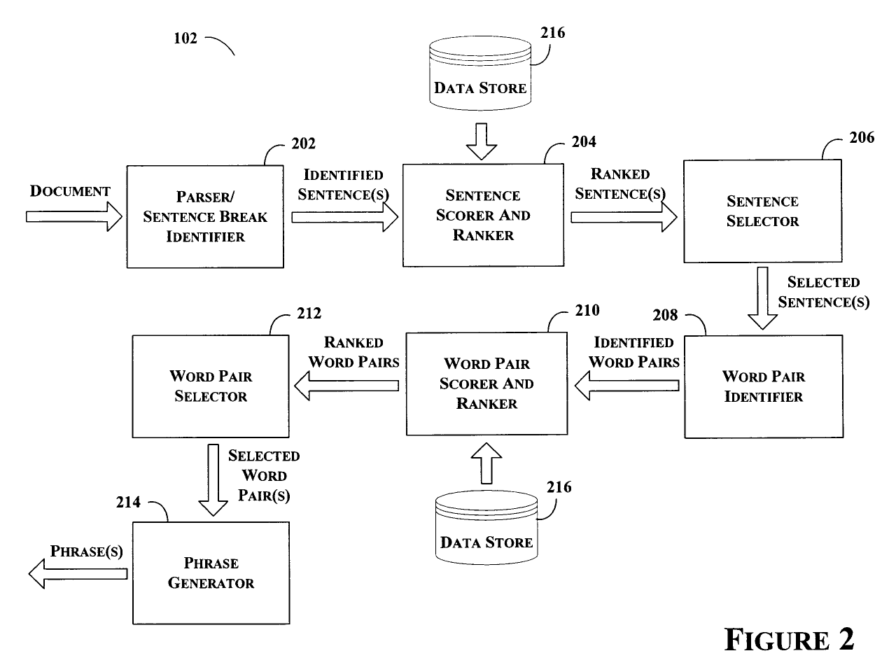

In accordance with one or more embodiments, phrase identification/generation system 102 generates phrases from selected sentences contained in a document input to the system 102. FIG. 2 provides an overview of components of phrase identification/generation system 102 in accordance with one or more embodiments of the present disclosure. A document is input to component 202, which comprises a parser and sentence break identifier. In accordance with one or more embodiments, component 202 parses the document to identify sentence breaks. By way of some non-limiting examples, sentence breaks can comprise any type of indication of a break, such as a logical break, including without limitation a period, question mark, as well as other punctuation, paragraph indicator, line feed indicator, spacing, capitalization, markup tags, etc. The sentences identified by component 202 can be forwarded to a sentence scorer/ranker 204, which scores the sentences identified by component 202 and ranks the identified sentences based on their scores relative to each other.

The ranked sentences are forwarded to a sentence selector 206, which selects a number of the identified sentences based on their scores and rankings. By way of a non-limiting example, sentence selector 206 ranks the identified sentences from highest score to lowest score, and selects a number of the top ranking, e.g., highest scoring, sentences. The selected sentences are forwarded to a word pair identifier 208, which identifies word pairs that occur in the selected sentences. In accordance with one or more embodiments, a word pair has two words occurring consecutively in a sentence. In accordance with one or more such embodiments, each word in a sentence is used in at least one word pair. By way of a non-limiting example, if a word is not the first or last word in a sentence, the word belongs to a word pair that includes the word's immediately-preceding word and a word pair that includes the word's immediately-succeeding word. By way of some further non-limiting examples, the first word in a sentence belongs to a word pair that includes the immediately-succeeding word, and the last word in a sentence belongs to a word pair that includes the immediately-preceding word.

The word pairs identified by the word pair identifier 208 are forwarded to a word pair scorer and ranker 210, which scores the identified word pairs and ranks the word pairs based on the scores. In accordance with one or more embodiments, word pairs with zero scores are excluded from the ranking, and the remaining word pairs, e.g., those with non-zero scores, are ranked from lowest at the top to highest at the bottom of the ranking. The ranked word pairs are forwarded to a word pair selector 212, which selects a number of the word pairs based on the word pair ranking. In accordance with one or more embodiments, the word pair selector 212 selects a number of the top ranking, e.g., lowest scoring, word pairs. The selected word pairs are forwarded to phrase generator 214, which generates a phrase using two of the selected word pairs.

In accordance with one or more embodiments, sentence scorer and ranker 204 can score a sentence using one or more scoring techniques, which can be used alone or in any combination. One such technique, which can be used with documents that are part of a set of search results generated from a search using one or more query terms, involves determining a number of occurrences of each of the one or more query terms found in a sentence. In addition to the query terms, this technique can expand the query terms to include synonyms and stem words, e.g., run and shoe are stem words of running and shoes, respectively. In such a case, the score can include occurrences of synonyms and stem words of query terms. In accordance with one or more such embodiments, the score assigned to the sentence reflects the number of occurrences of the query terms in the sentence.

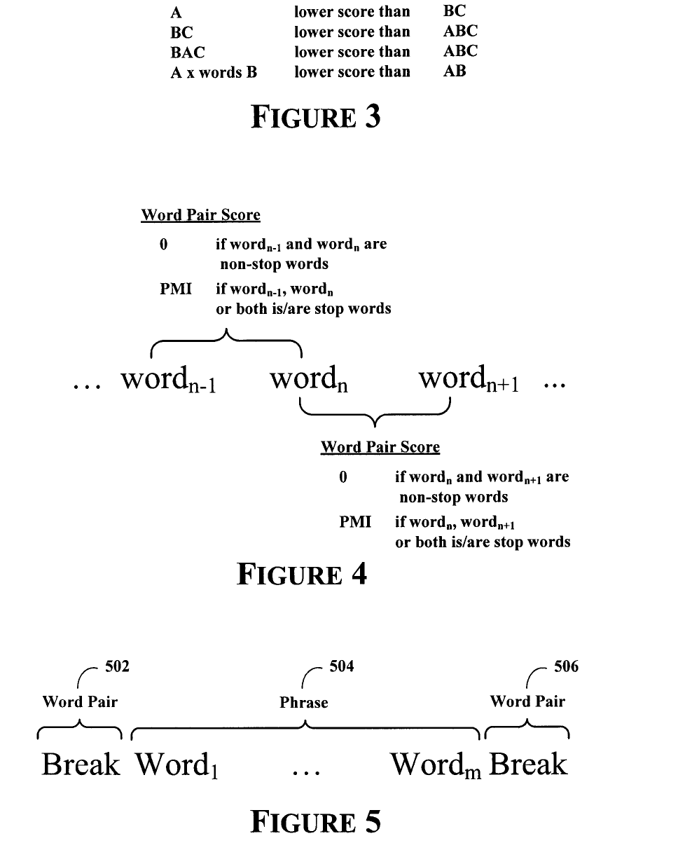

Another technique, which can be used in accordance with one or more embodiments, involves determining a score based on the proximity and/or ordering of query terms in a sentence. FIG. 3 provides some examples of scoring based on query term proximity and/or ordering in accordance with one or more embodiments of the present disclosure. The left-hand and right-hand columns provide exemplary occurrences of query terms A, B and C and the middle column identifies a comparative scoring. For example, an occurrence of query term A alone in a sentence would be given a lower score than an occurrence of query terms B and C found consecutively in the sentence. By way of another non-limiting example, an occurrence of query terms B and C found consecutively in the sentence would be given a lower score than an occurrence of query terms A, B and C found consecutively in the sentence. The ordering of the query terms in the sentence can impact the score. For example, in a case that the order of the query terms in a query is A, followed by B followed by C, an occurrence of the query terms B, A, C, in that order, in a sentence would be assigned a lower score than if the query terms occurred in the sentence in the order that the terms appeared in the query, i.e., A, B and C. By way of yet another non-limiting example, the number of words that occur between two query terms can impact a sentence's score, such that an occurrence of query terms A and B with some number of interceding words would be assigned a lower score than if query term B immediately followed query term A, or vice a versa.

In accordance with one or more embodiments, a sentence score can be determined in whole or in part based on an occurrence of words in the sentence determined to be “important” words. By way of a non-limiting example, words can be predetermined to be important words, and can include query terms determined to occur frequently in queries and/or include query terms that occur in high frequency queries. In accordance with one or more such embodiments, a set of important words can be predetermined, or pre-trained, e.g., by a review of query logs and/or other historical information, and sentence scorer and ranker 204 can determine whether or not the sentence includes one or more of the important words identified in the predetermined set. Data store 216 of FIG. 2 can be used to store a set of important words.

Another technique, which can be used in accordance with one or more embodiments, to score a sentence, involves determining the presence of types of words in the sentence, such as proper names, dates, place names, names of people, etc. In accordance with one or more such embodiments, a set of word types can be predetermined, or pre-trained, e.g., by review of query logs and/or other historical information, and sentence scorer and ranker 204 can determine whether or not the sentence includes one or more of the types identified in the predetermined set. Data store 216 of FIG. 2 can be used to store a set of important words.

In accordance with one or more embodiments, word pair scorer and ranker 210 scores each word pair identified by word pair identifier 208. FIG. 4 provides an example of word pair scoring in accordance with one or more embodiments of the present disclosure. Three words, word, wordₙ₋₁, wordₙ, and wordₙ₊₁, are shown in the example. Two word pairs can be created from wordₙ₋₁, wordₙ, and wordₙ₊₁, e.g., a word pair of wordₙ₋₁ and wordₙ and a word pair of wordₙ and wordₙ₊₁. In accordance with one or more such embodiments, a word pair score is based on whether a word in the word pair is a stop word or a non-stop word. In accordance with at least one of the embodiments, a stop word, or noise word, is a “high occurrence” word, which is typically filtered out, or excluded, from consideration. By way of a non-limiting example, a search engine typically ignores stop words when indexing and/or searching documents. Some examples of stop words include, without limitation, words such as “the,” “was,” “and,” etc., and types of words such as pronouns, conjunction, interjection, etc. Stop words can be identified by, for example, processing a number of documents, as a training set, to identify words that occur in the documents, count the number of occurrences of each of the identified words, rank the words based on their number of occurrences and select a number, e.g., 75 for 400, of the words that occur most frequently in the documents. Words that are not selected as stop words are considered to be non-stop words, e.g., words other than stop words. Data store 216 of FIG. 2 can be used to store the identified stop words.

Referring to FIG. 4, the word pair containing wordₙ₋₁ and wordₙ is assigned a score of zero in a case that wordₙ₋₁ and wordₙ are both non-stop words. In a case that one or both of wordₙ₋₁ and wordₙ are stop words, a word pair score representing a pointwise mutual information (PMI) score is assigned to the word pair. The PMI score represents an affinity, or attachment, measure for the two words. The PMI score can represent a measure of the strength of an attraction between the two words, e.g., based on a frequency by which the two words appear together. A PMI score for two words can be identified by, for example, processing a number of documents, as a training set, to count the number of times the two words appear together, e.g., consecutively, and the number of times that the two words appear separately, e.g., with one or more words occurring between the two words and/or one of the two words missing, in the documents. The PMI score for the two words can determined to be the ratio of the number of times the words appeared together (e.g., the numerator of the ratio) to the number of times the words appeared separately (e.g., the denominator of the ratio). Word pairs and the corresponding PMI score for each word pair can be stored in data store 216. A similar approach can be used to score the word pair of wordₙ and wordₙ₊₁.

In accordance with one or more embodiments, word pairs are ranked according to their scores, and word pair selector 212 selects word pairs according to their ranking. In accordance with one or more embodiments, the word pairs having a zero score are excluded from the ranking, word pairs with non-zero scores are ranked from lowest to highest scores, and word pair selector 212 selects a number of the lowest scoring word pairs. Using this approach, the word pairs having words that, e.g., based on the training data, are considered to not occur together that frequently are selected, so that a break involving the word pair would likely be at a logical point in the sentence, e.g., a logical or natural break in the sentence.

Phrase generator 214 generates a phrase using the selected word pairs. In accordance with one or more embodiments, a break can occur between the two words of a word pair. This approach might be used, for example, in a case that the word pair includes a stop word and a non-stop word, so that the non-stop word can be included in the generated phrase. In accordance with one or more alternate embodiments, a break occurs after or before a word pair. This approach might be used, for example, in a case that the word pair includes two stop words, so that the stop words can be excluded from the generated phrase. FIG. 5 provides an example of a phrase generated by phrase generator 214 in accordance with one or more embodiments of the present disclosure. Phrase 504 provides an example of a phrase that can be generated by phrase generator 214 using selected word pairs. Phrase 504 comprises text, e.g., word₁ to wordₘ, which occurs after word pair 502 and before word pair 506. Word pairs 502 and 506 are word pairs selected by word pair selector 212.

In accordance with one or more embodiments, one or more rules can be used for generating a phrase by breaking a sentence at word pairs. By way of a non-limiting example, one such role is that a break is not made between two non-stop words. By way of another non-limiting example, a break can occur using a word pair that includes a stop word and a non-stop word, or using a word pair that includes two stop words. In the case of a word pair that includes at least one stop word, a break can occur between the words of the word pair, for example.

In accordance with one or more embodiments, one or more phrases generated by phrase generator 214 are used by summary generation system 104 to generate a summary of the document that contains the phrase(s) generated by phrase generator 214. In accordance with one or more such embodiments, summary generation system 104 can be a web search engine/system, such that a summary corresponding to each document selected by the web search engine/system is returned to the user in response to a query entered by the user. By way of a non-limiting example, each document in the search results has an entry in the search results, which includes a title, the summary, and a link, e.g., a Universal resource locator (URL), to the document.

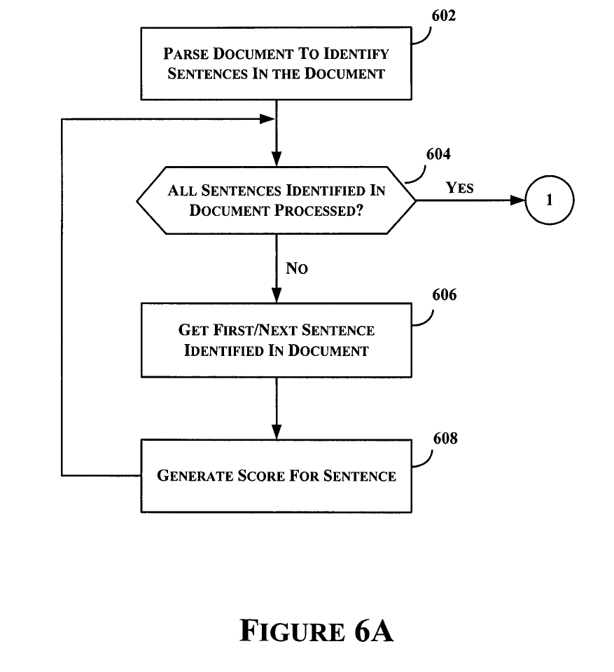

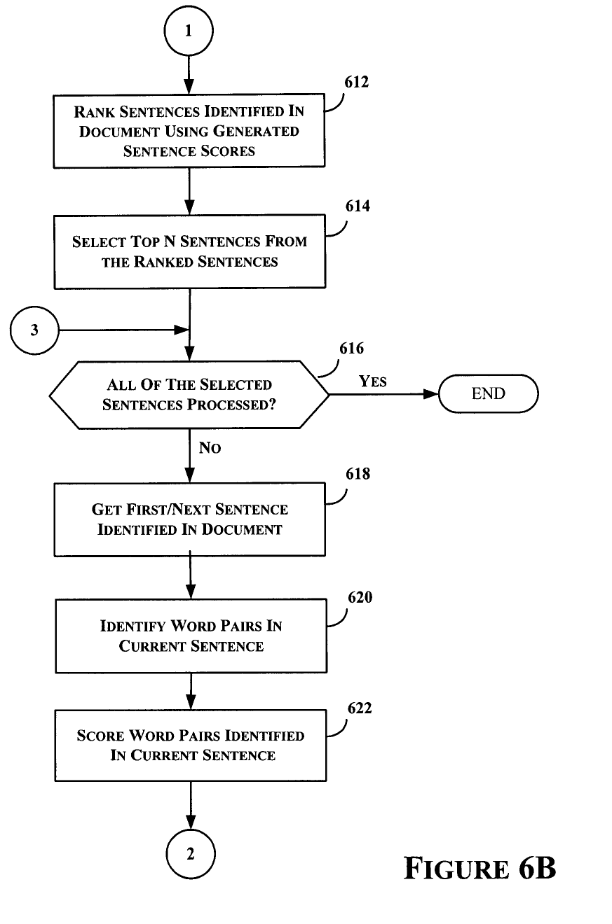

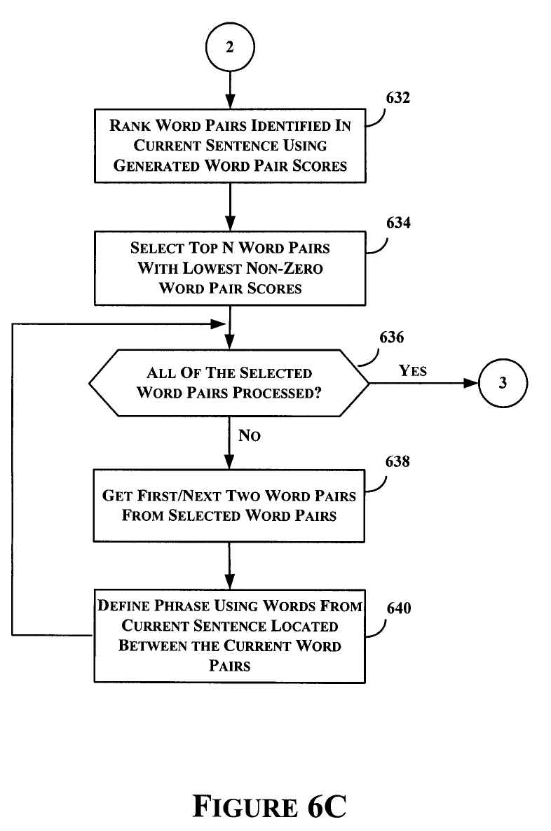

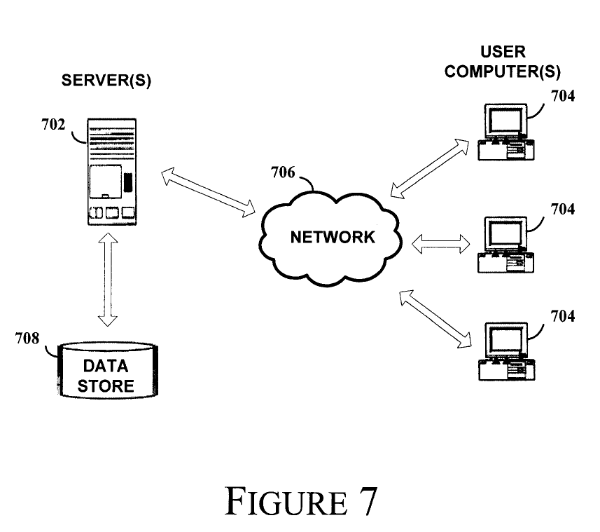

In accordance with one or more embodiments of the present disclosure, a phrase generation process flow is shown in FIG. 6, which comprises FIGS. 6A to 6C. The phrase generation process flow of FIG. 6 can comprise a method in accordance with one or more embodiments of the present disclosure. In addition and in accordance with one or more embodiments, the phrase generate process flow can be tangibly embodied in program code that can be used to configure a computer to implement the phrase generation process flow, the program code being tangibly embodied and stored on a computer-readable medium. In accordance with one or more embodiments, the phrase generation process flow can be implements by components of the phrase identification/generation system 102 of FIG. 1.

At step 602 of FIG. 6A, a document is parsed to identify sentence breaks and sentences in the document. At step 604, a determination is made whether or not all of the sentences identified in step 602 have been processed. If all of the sentences identified in step 602 have been processed, processing continues at step 612 of FIG. 6B. If it is determined at step 604 that sentences remain to be processed, processing continues at step 606 to get the next/first sentence identified in the document. At step 608, a score is generated for the sentence, and processing continues at step 604 to process any remaining sentences.

Once all of the identified sentences have been scored, processing continues at step 612 of FIG. 6B, and the sentences are ranked based on their relative scores. At step 614, a number of the top-ranking sentences are selected. By way of some non-limiting examples, the number of sentences can be dependent on a number of phrases to be generated and/or a size of a summary that is to be generated for a document. By way of a further non-limiting example, two phrases are to be generated for each document, and two sentences are selected. At step 616, a determination is made whether or not all of the sentences selected in step 614 have been processed. If not, processing continues at step 618 to get the first/next sentence selected in step 614. At step 620, word pairs are identified in the current sentence. At step 622, the word pairs identified in the current sentence are scored.

Referring to FIG. 6C, processing continues at step 632 to rank the word pairs identified in step 620 of FIG. 6B for the current sentence using the scores generated in step 622 of FIG. 6B. A number of the top ranked word pairs are selected at step 634 of FIG. 6C. By way of some non-limiting examples, the number of word pairs selected can be dependent on the number of word pairs identified in the sentence, the number of phrases to be generated for the sentence or document, and/or the size of the summary that is to be generated for the document. By way of a further non-limiting example, one phrase is to be generated for each sentence, and two word pairs are selected. As discussed above, in accordance with one or more embodiments, the selected word pairs are the lowest scoring word pairs. At step 636, a determination is made whether or not all of the selected word pairs have been processed. If not, processing continues at step 638 to get the first/next two word pairs from the selected word pairs. At step 640, a phrase is defined using words from the current sentence using the word pairs. Processing continues at step 636 to process any remaining selected word pairs.

FIG. 7 illustrates some components that can be used in connection with one or more embodiments of the present disclosure. In accordance with one or more embodiments of the present disclosure, one or more computing devices, e.g., one or more servers, 702 are configured to comprise functionality described herein. For example, a computing device 702 can be configured as one or more of the components shown in FIGS. 1 and 2. A computing device 702 can be configured to provide phrase identification/generation system 102 and/or summary generation system 104. A computing device 702 can be configured to provide a web search engine, which comprises the summary generation system 104, and can further be configured to provide one more of a crawler, e.g., configured to locate documents on the web, an indexer, e.g., configured to index located documents, a searcher, e.g., configured to search indexed documents, and ranker, e.g., configured to rank the documents found in a search. Data store 708 can comprise data store 216 of FIG. 2. It should be apparent that one or more of the phrase identification/generation system 102 and summary generation system 104 can be the same computing device 702, or can be different instances of computing device 702. Computing device 702 can serve content to user computers 704 using a browser application via a network 706.

The user computer 704 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 702 and the user computer 704 can include one or more processors, memory, a removable media reader, network interface, display and interface, and one or more input devices, e.g., keyboard, keypad, mouse, etc. and input device interface, for example. One skilled in the art will recognize that server 702 and user computer 704 may be configured in many different ways and implemented using many different combinations of hardware, software, or firmware.

In accordance with one or more embodiments, a computing device 702 can make a user interface available to a user computer 704 via the network 706. The user interface made available to the user computer 704 can include one or more summaries generated by summary generation system 104 using phrases generated by phrase identification/generation system 102. In accordance with one or more embodiments, computing device 702 makes a user interface available to a user computer 704 by communicating a definition of the user interface to the user computer 704 via the network 706. The user interface definition can be specified using any of a number of languages, including without limitation a markup language such as Hypertext Markup Language, scripts, applets and the like. The user interface definition can be processed by an application executing on the user computer 704, such as a browser application, to output the user interface on a display coupled, e.g., a display directly or indirectly connected, to the user computer 704.

In an embodiment the network 706 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 7. Alternatively, embodiments of the present disclosure can be implemented other environments, e.g., a peer-to-peer environment as one non-limiting example.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
identifying word pairs in a sentence selected from a document, each word pair having consecutive first and second words;
generating, for each of the identified word pairs, a word pair score;
selecting at least two of the identified word pairs based on the word pair score relative to word pair scores of other ones of the identified word pairs; and
identifying at least one phrase from the document, each identified phrase being defined by two of the selected word pairs.

2. The method of claim 1, further comprising:
generating a summary of the document that includes the at least one phrase from the document.

3. The method of claim 1, wherein the document is a part of a set of search results selected from a query comprising one or more search terms, and wherein the selected sentence includes at least one of the one or more search terms.

4. The method of claim 3, further comprising:
identifying sentences in the document using sentence breaks.

5. The method of claim 4, further comprising:
choosing the selected sentence from the sentences identified in the document, the selected sentence including at least one of the one or more search terms.

6. The method of claim 4, further comprising:
generating a score for each of the sentences identified in the document;
ranking the sentences identified in the document based on generated scores;
choosing the selected sentence from the sentences identified in the document using the ranking.

7. The method of claim 6, wherein the document is part of a set of search results selected from a query comprising one or more search terms, said generating a score for each of the sentences identified in the document further comprising:
generating a score for each of the sentences identified in the document based at least in part on a determined number of occurrences of the search terms in the identified sentence.

8. The method of claim 6, wherein the document is part of a set of search results selected from a query comprising one or more search terms, said generating a score for each of the sentences identified in the document further comprising:
generating a score for each of the sentences identified in the document based at least in part on a determined proximity of the search terms in the sentence.

9. The method of claim 6, said generating a score for each of the sentences identified in the document further comprising:
generating a score for each of the sentences identified in the document based at least in part on a determined number of occurrences in the sentence of one or more important words from a pre-determined set of important words.

10. The method of claim 6, said generating a score for each of the sentences identified in the document further comprising:
generating a score for each of the sentences identified in the document based at least in part on a determined number of occurrences in the sentence of one or more word types from a pre-determined set of word types.

11. The method of claim 1, said generating, for each of the identified word pairs, a word pair score further comprising:
assigning a zero score to a word pair in a case that both of the words in the word pair are non-stop words; and
obtaining a non-zero score for the word pair in a case that it is determined that at least one of the words in the word pair is a stop word, the non-zero score for the word pair representing a pre-determined affinity between the words of the word pair.

12. The method of claim 1, said identifying at least one phrase from the document, each identified phrase being defined by two of the selected word pairs further comprising:
setting a first break point using one of the two selected word pairs;
setting a second break point using another of the two selected word pairs;
selecting one or more words located between the first and second break points for the at least one phrase.

13. The method of claim 12, wherein the at least one phrase includes at least one word from at least one of the selected word pairs.

14. Computer-readable program code tangibly embodying program code stored thereon, the program code comprising:
code to identify word pairs in a sentence selected from a document, each word pair having consecutive first and second words;
code to generate, for each of the identified word pairs, a word pair score;
code to select at least two of the identified word pairs based on the word pair score relative to word pair scores of other ones of the identified word pairs; and
code to identify at least one phrase from the document, each identified phrase being defined by two of the selected word pairs.

15. The medium of claim 14, the program code further comprising:
code to generate a summary of the document that includes the at least one phrase from the document.

16. The medium of claim 14, wherein the document is a part of a set of search results selected from a query comprising one or more search terms, and wherein the selected sentence includes at least one of the one or more search terms.

17. The medium of claim 16, the program code further comprising:
code to identify sentences in the document using sentence breaks.

18. The medium of claim 17, the program code further comprising:
code to choose the selected sentence from the sentences identified in the document, the selected sentence including at least one of the one or more search terms.

19. The medium of claim 17, the program code further comprising:
code to generate a score for each of the sentences identified in the document;
code to rank the sentences identified in the document based on generated scores;
code to choose the selected sentence from the sentences identified in the document using the ranking.

20. The medium of claim 19, wherein the document is part of a set of search results selected from a query comprising one or more search terms, the code to generate a score for each of the sentences identified in the document further comprising:
code to generate a score for each of the sentences identified in the document based at least in part on a determined number of occurrences of the search terms in the identified sentence.

21. The medium of claim 19, wherein the document is part of a set of search results selected from a query comprising one or more search terms, the code to generate a score for each of the sentences identified in the document further comprising:
code to generate a score for each of the sentences identified in the document based at least in part on a determined proximity of the search terms in the sentence.

22. The medium of claim 19, the code to generate a score for each of the sentences identified in the document further comprising:
code to generate a score for each of the sentences identified in the document based at least in part on a determined number of occurrences in the sentence of one or more important words from a pre-determined set of important words.

23. The medium of claim 19, the code to generate a score for each of the sentences identified in the document further comprising:
code to generate a score for each of the sentences identified in the document based at least in part on a determined number of occurrences in the sentence of one or more word types from a pre-determined set of word types.

24. The medium of claim 14, the code to generate, for each of the identified word pairs, a word pair score further comprising:
code to assign a zero score to a word pair in a case that both of the words in the word pair are non-stop words; and
code to obtain a non-zero score for the word pair in a case that it is determined that at least one of the words in the word pair is a stop word, the non-zero score for the word pair representing a pre-determined affinity between the words of the word pair.

25. The medium of claim 14, code to identify at least one phrase from the document, each identified phrase being defined by two of the selected word pairs further comprising:
code to set a first break point using one of the two selected word pairs;
code to set a second break point using another of the two selected word pairs;
code to select one or more words located between the first and second break points for the at least one phrase.

26. The medium of claim 25, wherein the at least one phrase includes at least one word from at least one of the selected word pairs.

27. A system comprising:
a phrase identification/generation system configured to:
identify word pairs in a sentence selected from a document, each word pair having consecutive first and second words;
generate, for each of the identified word pairs, a word pair score;
select at least two of the identified word pairs based on the word pair score relative to word pair scores of other ones of the identified word pairs; and
identify at least one phrase from the document, each identified phrase being defined by two of the selected word pairs.

28. The system of claim 27, further comprising:
a summary generation system configured to generate a summary of the document that includes the at least one phrase from the document.

29. The system of claim 27, wherein the document is a part of a set of search results selected from a query comprising one or more search terms, and wherein the selected sentence includes at least one of the one or more search terms.

30. The system of claim 29, the phrase identification/generation system being further configured to:
identify sentences in the document using sentence breaks.

31. The system of claim 30, the phrase identification/generation system being further configured to:
choose the selected sentence from the sentences identified in the document, the selected sentence including at least one of the one or more search terms.

32. The system of claim 30, the phrase identification/generation system being further configured to:
generate a score for each of the sentences identified in the document;
rank the sentences identified in the document based on generated scores;
choose the selected sentence from the sentences identified in the document using the ranking.

33. The system of claim 32, wherein the document is part of a set of search results selected from a query comprising one or more search terms, the phrase identification/generation system configured to generate a score for each of the sentences identified in the document being further configured to:
generate a score for each of the sentences identified in the document based at least in part on a determined number of occurrences of the search terms in the identified sentence.

34. The system of claim 32, wherein the document is part of a set of search results selected from a query comprising one or more search terms, the phrase identification/generation system configured to generate a score for each of the sentences identified in the document being further configured to:
generate a score for each of the sentences identified in the document based at least in part on a determined proximity of the search terms in the sentence.

35. The system of claim 32, the phrase identification/generation system configured to generate a score for each of the sentences identified in the document being further configured to:
generate a score for each of the sentences identified in the document based at least in part on a determined number of occurrences in the sentence of one or more important words from a pre-determined set of important words.

36. The system of claim 32, the phrase identification/generation system configured to generate a score for each of the sentences identified in the document being further configured to:
generate a score for each of the sentences identified in the document based at least in part on a determined number of occurrences in the sentence of one or more word types from a pre-determined set of word types.

37. The system of claim 27, the phrase identification/generation system configured to generate, for each of the identified word pairs, a word pair score being further configured to:
assign a zero score to a word pair in a case that both of the words in the word pair are non-stop words; and
obtain a non-zero score for the word pair in a case that it is determined that at least one of the words in the word pair is a stop word, the non-zero score for the word pair representing a pre-determined affinity between the words of the word pair.

38. The system of claim 27, the phrase identification/generation system configured to identify at least one phrase from the document, each identified phrase being defined by two of the selected word pairs being further configured to:
set a first break point using one of the two selected word pairs;
set a second break point using another of the two selected word pairs;
select one or more words located between the first and second break points for the at least one phrase.

39. The system of claim 38, wherein the at least one phrase includes at least one word from at least one of the selected word pairs.
